(19) United States
(12) Patent Application Publication
(10) Pub. No.: US 2014/0116306 A1
(43) Pub. Date: May 1, 2014

(54) TWO-ROW PLANTER ASSEMBLY

(71) Applicant: Jason Sharp, Shelbyville, IN (US)

(72) Inventor: Jason Sharp, Shelbyville, IN (US)

(21) Appl. No.: 14/063,169

(22) Filed: Oct. 25, 2013

Related U.S. Application Data
(60) Provisional application No. 61/718,855, filed on Oct. 26, 2012.

(51) Int. Cl. A01B 49/06; A01B 49/02

(52) U.S. Cl. CPC A01B 49/06; A01B 49/02
USPC 111/163

(57) ABSTRACT

The present disclosure provides a planter assembly to be driven by a single-point hitch machine. The planter assembly includes a coupler having a first end coupled to the hitch and a second end coupled to a tool bar via a coupler plate. The coupler plate includes a plurality of defined openings for adjustably coupling the tool bar to the coupler. A frame is coupled to the tool bar and a swing arm is pivotally coupled to the frame. The swing arm is pivotable between a first position and a second position. A wheel is coupled to the swing arm and a final drive sprocket is coupled to the frame. The final drive sprocket is engaged with a drive chain when the swing arm is in the first position and disengaged from the drive chain when the swing arm is in the second position.

### CROSS-REFERENCE TO RELATED APPLICATIONS

This application claims priority to U.S. Provisional Patent Application Ser. No. 61/718,855, filed Oct. 26, 2012, which is hereby incorporated by reference in its entirety.

### FIELD OF THE DISCLOSURE

The present disclosure is related to a planter assembly, and in particular to an adjustable planter assembly for distributing different seed types.

### BACKGROUND

Planters are utilized extensively by farmers and the like to plant different types of crops. Conventional large scale planters are designed to work exclusively with large tractors and to plant many rows of crops at the same time. There are also conventional small scale planters designed for the recreational gardener that allow for planting 1 or 2 rows of seed at the same time. These smaller planters are hand powered or require a special 3-point hitch that is not found on a common lawn-mower or other similar off-road vehicle. Currently there are limited options for the recreational gardener who would like to plant a field using a pull-behind planter.

In addition, the current methods for planting are undesirable for several reasons. First, many of the options require special tractors with a 3-point hitch. These tractors can be expensive and unnecessarily large for a recreational gardener. Also, many of these planters have limited options when it comes to the type of seed being planted. Finally, many of the options are manually driven and can only plant one row at a time. This is very tedious and cumbersome for planting a field with many rows. Manual planters require the operator to physically push the planter the entire length of each row to be planted. This can be physically demanding on the person operating the planter.

Thus, a need exists for a pull-behind planter that can be adjusted to accommodate various hitch heights and different seed types. Further, there is a need for a planter that can be pulled behind a traditional riding lawn-mower or ATV with a single point hitch.

### SUMMARY

In one embodiment of the present disclosure, a planter assembly is provided for being driven by a single-point hitch machine for planting seed. The planter assembly includes a coupler having a first end and a second end, the first end configured to be coupled to the single point hitch of the machine; a tool bar coupled to the second end of the coupler via a coupler plate, the coupler plate including a plurality of defined openings for adjustably coupling the tool bar to the coupler; a frame coupled to the tool bar; a swing arm pivotally coupled to the frame, the swing arm being pivotable between a first position and a second position; a wheel for propelling the planter assembly, the wheel being coupled to the swing arm; and a final drive sprocket coupled to the frame, the final drive sprocket being engaged with a drive chain when the swing arm is in the first position and disengaged from the drive chain when the swing arm is in the second position.

In one example of this embodiment, the second end of the coupler is adjustably coupled to the tool bar via the plurality of openings defined in the coupler plate. In a second example, the wheel is in contact with the underlying surface in both the first position and the second position. In a third example, the planter assembly includes a seed hopper including a plurality of sides that define an interior configured to hold seeds; a seed hub disposed in the interior of the seed hopper, the seed hub rotatably driven by the wheel; and a seed disc rotatably coupled to the seed hub; wherein, rotation of the seed hub induces substantially concomitant rotation of the seed disc. In a fourth example, a seed disc sprocket is rotatably coupled to the seed hub, wherein in the first position the wheel is rotatably coupled to the seed hub.

In a fifth example, when the swing arm is in the second position, the seed hub is decoupled from the wheel. In a sixth example, the planter assembly includes a reinforcement block disposed adjacent to the drive chain, wherein when the swing arm is in the first position the final drive sprocket contacts the drive chain and forces the drive chain against the reinforcement block. In a seventh example, the planter assembly includes a marker having a first end and a second end, the marker including a head removably coupled to the first end and being pivotally coupled to the frame at the second end. In an eighth example, the marker is pivotable relative to the frame between an engaged position and a disengaged position; further wherein, in the disengaged position the marker is disposed in an upright position, and in the engaged position the marker is pivotably disposed at a substantially perpendicular position relative to the upright position such that the head is disposed in contact with an underlying surface.

In another embodiment, a planting machine is provided for distributing multiple rows of seed. The planting machine includes a powered machine including a single point hitch; a planter assembly including a frame; a first wheel and a second wheel for propelling the machine along an underlying surface, the first wheel and the second wheel coupled to the frame; a coupling mechanism having a first end and a second end, the first end being coupled to the single point hitch and the second end being coupled to the frame; a first swing arm coupled to a first side of the frame and a second swing arm coupled to a second side of the frame, the first side being opposite the second side; a swing arm cross member coupled between the first swing arm and the second swing arm; and a trip lever coupled to the swing arm cross member, the trip lever being pivotable between a first position and a second position; wherein, as the trip lever is pivoted from the first position to the second position, the first swing arm and the second swing arm move the frame relative to the underlying surface.

In one example, the planter machine includes a first seed hopper adjustably coupled to the first side of the frame, the first seed hopper including a first seed disc hub rotatably coupled to the first seed hopper; a second seed hopper adjustably coupled to the second side of the frame, the second seed hopper including a second seed disc hub rotatably coupled to the second seed hopper; a first seed disc rotatably coupled to the first seed disc hub; a second seed disc rotatably coupled to the second seed disc hub; wherein, when the trip lever is in the first position, the first seed disc hub is rotatably coupled to the first wheel and the second seed disc hub is rotatably coupled to the second wheel.

In a second example, the planter machine includes a first seed distribution assembly coupled to the first seed hopper, the first seed distribution assembly including a first guide and a first distribution tube, where the first guide is coupled to the first seed hopper and is configured to receive a seed from the first seed disc and guide the received seed to the first distribution tube; a second seed distribution assembly coupled to the second seed hopper, the second seed distribution assembly including a second guide and a second distribution tube, where the second guide is coupled to the second seed hopper and is configured to receive a seed from the second seed disc and guide the received seed to the second distribution tube; a first disc opener coupled to the first side of the frame, the first disc opener being movable between a raised position and a lowered position, where in the lowered position the first disc opener is configured to engage the underlying surface and form a first furrow; and a second disc opener coupled to the second side of the frame, the second disc opener being movable between a raised position and a lowered position, where in the lowered position the second disc opener is configured to engage the underlying surface and form a second furrow; wherein, the first distribution assembly is adapted to transfer a seed from the first seed hopper and release it into the first furrow, and the second distribution assembly is adapted to transfer a seed from the second seed hopper and release it into the second furrow.

In a third example, the planter machine includes a first drag chain coupled to the first disc opener; and a second drag chain coupled to the second disc opener; wherein, the first drag chain is configured to cover the seed released in the first furrow with a portion of the underlying surface, and the second drag chain is configured to cover the seed released in the second furrow with a portion of the underlying surface. In a fourth example, the first seed disc and the second seed disc each comprise a substantially disc-shaped body, the disc-shaped body including a substantially centrally-defined bore for coupling to the first or second seed disc hub, an outer disc guard that forms an outer lip, and a plurality of defined openings radially offset from one another; and the first seed hopper and the second seed hopper each include a plurality of sides, where at least one of the plurality of sides defines an opening; further wherein, during rotation of the first or second seed disc hub, at least one of the plurality of defined openings in the disc-shaped body of the corresponding seed disc is substantially aligned with the opening defined in the corresponding seed hopper to release a seed from the corresponding seed hopper through the aligned openings.

In a fifth example, the planter machine includes a drive sprocket rotatably coupled to one end of the first or second swing arm, the drive sprocket being rotatably driven by the first or second wheel; a driven sprocket coupled to an opposite end of the first or second swing arm and fixedly coupled to the frame; a drive chain coupled between the drive sprocket and the driven sprocket; an idler sprocket coupled to the frame, the idler sprocket positioned adjacent to the driven sprocket; a seed disc sprocket coupled to the first or second seed hopper, the seed disc sprocket rotatably coupled to the first or second seed disc such that rotation of the seed disc sprocket induces substantially concomitant rotation of the first or second seed disc; a seed disc chain coupled between the seed disc sprocket and the idler sprocket; wherein, rotation of the first or second wheel induces rotation of the first or second seed disc hub via the drive chain and the seed disc chain.

In a different embodiment of this disclosure, a two-row planting assembly is provided for being driven by a machine having a single-point hitch. The two-row planting assembly includes a frame; a coupling mechanism having a first end and a second end, the first end being coupled to the frame and the second end configured to be coupled to the single-point hitch; a wheel coupled to the frame and configured to propel the two-row planting assembly along an underlying surface; a disc opener adjustably coupled to the frame, the disc opener configured to form a furrow in the underlying surface; a drag chain adjustably coupled to the frame, the drag chain configured to be dragged behind the disc opener and cover up the furrow with a portion of the underlying surface; a seed hopper coupled to the frame, the seed hopper including a plurality of sidewalls that define an interior for holding seed; a seed hub rotatably coupled to one of the plurality of sidewalls; a seed disc including a defined bore and a plurality of openings radially spaced from the defined bore and each other, the seed disc being rotatably coupled to the seed hub; a swing arm pivotally coupled to the frame, the swing arm configured to have a first position and a second position; a plurality of sprockets coupled to the wheel, swing arm, frame, and disc hub; a trip lever pivotally coupled to the frame, the trip lever being movable between an engaged position and a disengaged position; wherein, in the first position the disc opener is adapted to engage the underlying surface and a rotation of the wheel induces substantially concomitant rotation of the seed disc, and in the second position the disc opener is disposed in a position in which the disc opener is not configured to engage the underlying surface.

In one example of this embodiment, when the trip lever is in the engaged position, the swing arm is in the first position; and when the trip lever is in the disengaged position, the swing arm is in the second position. In a second example, the planting assembly includes a marker pivotally coupled to the frame, the marker being disposable between a lowered position and a raised position; a marker head coupled to the marker, wherein in the lowered position the marker head is configured to contact the underlying surface; and a marker lock coupled to the frame, the marker lock removably coupling the marker to the frame in the raised position. In a third example, the planting assembly includes a connecting line coupled to the trip lever and the marker; a pulley coupled to the frame, the pulley configured to partially guide the connecting line from the trip lever to the marker; and a pull string coupled to the marker lock; wherein, in the raised position a movement of the pull string releases the marker from the frame and induces the marker to move from the raised position to the lowered position. In a fourth example, the marker is disposed in the first position when the trip lever is disposed in the disengaged position; and the marker is disposed in the second position when the trip lever is disposed in the engaged position.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings wherein;

FIG. 1 is a front side perspective view of an embodiment of a seed planter;

FIG. 2 is a back side perspective view of the planter in FIG. 1;

FIG. 3 is a left side view of the planter in FIG. 1 in an engaged position;

FIG. 4 is a right side view of the planter of FIG. 1 in the engaged position;

FIG. 5 is a right side view of the planter of FIG. 1 in the disengaged position;

FIG. 6 is a perspective view of a seed hopper with a seed disc coupled to a hub;

FIG. 7 is a perspective view of a seed hopper without a seed disc coupled to the hub; and

FIG. 8 is a rear view of the planter in FIG. 1 in the engaged position with a marker extended.

Corresponding reference numerals are used to indicate corresponding parts throughout the several views.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The present disclosure relates to a planting assembly that utilizes a single location adjustable hitch to be compatible with multiple vehicle applications.

One embodiment of a planter assembly involves a single-point adjustable coupler to connect the planter assembly to a guiding vehicle. The power train of a guiding vehicle may pull the planter assembly by engaging the planter assembly's drive wheel or wheels with the underlying surface. As a drive wheel of the planter assembly rotates, an axle of the drive wheel can rotate a drive system for a seed disc. The planter assembly may have an engaged position where the seed disc is coupled to the drive system and the disc openers engage the ground to create a furrow. Further, the disc openers can have a seed distribution tube located in a position to direct a seed to be distributed into the furrow created by the seed disc. The seed discs can distribute seed to the seed distribution tube from a seed hopper in the desired intervals. Finally, a drag chain may cover the furrow after the seed has been distributed therein.

When the planter assembly is in the disengaged position, the seed disc no longer rotates as the drive wheel or wheels rotate and the disc openers no longer contact the underlying ground.

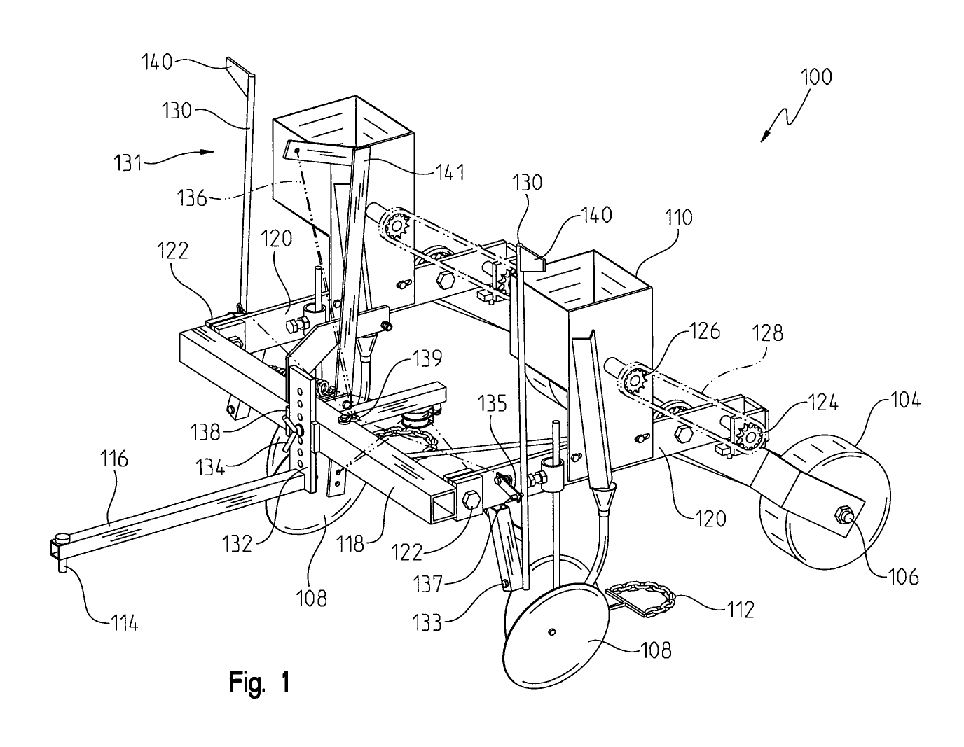

In the embodiment shown in FIG. 1, the planter assembly 100 can include a steel frame, or tool bar 118. The tool bar 118 is not limited to being made of steel as other materials such as aluminum would suffice given the appropriate material properties. The tool bar 118 may be connected to a guiding vehicle at a single location by a coupler 114 via a coupler rail 116 that can be adjusted to accommodate several hitch heights. In one example, the coupler 114 can be a bolt, screw, a trailer ball receiver, or other fastener. Further, the frame can include a planter frame member 120 that is coupled to the tool bar 118 at one or more attachment locations 122. The attachment locations 122 for the planter frame member 120 should not be limited to any one fixed position. One skilled in the art would understand how this attachment location 122 can be adjustable on the tool bar 118 and allow for varying row widths.

Further, in FIG. 1, the coupler 114 is shown. The coupler 114 can couple to the tool bar 118 via the coupler rail 116 and a coupler plate 132. The coupler 114 may be removably coupled to the coupler rail 116 on a first end by removable fasteners such as bolts, screws or the like. The coupler 114 may also be fixedly coupled to the coupler 114 by welded, soldering, gluing or the like. Further, the coupler rail 116 may be coupled at a second end to the coupler plate 132 by bolts, screws, welds, glue, solder or any other similar means of fixedly or removably coupling. The coupler plate 132 may connect to the tool bar 118 through a plurality of holes defined in the coupler plate 132. The coupler plate 132 can be set between guides 138 that ensure the coupler plate 132 maintains the same orientation throughout the planting process. The single point coupler 114 can be adjusted to accommodate a plurality of hitch heights by selecting the appropriate corresponding hole in the coupler plate 132 and coupling the coupler plate 132 to the tool bar 118 between the guides 138 with a coupler plate locking mechanism 134. This method of adjusting the hitch height is not exclusive, i.e., other embodiments may use different adjustable means to achieve the desired hitch height such as a sliding tube and clamp, or slotted mounting holes for a coupler plate.

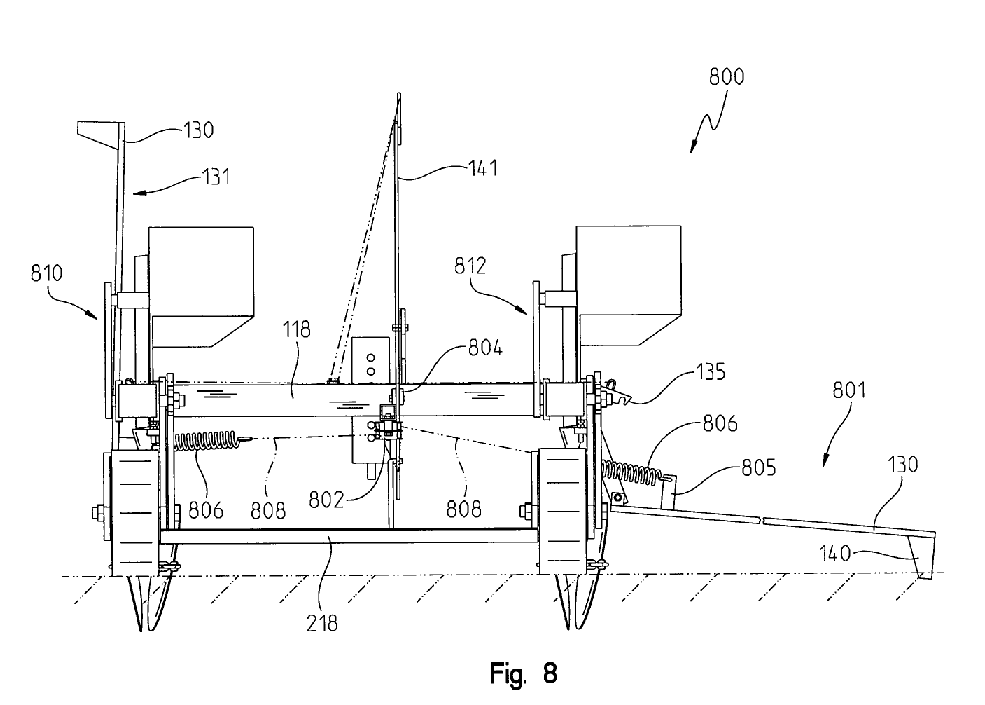

In FIG. 1 marker arms 130 are shown in a first position 131. The marker arms 130 can be pivotally mounted to the frame member 120 at pivot points 133. The marker arms 130 can have a removably coupled marker head 140 that can be removably coupled to the marker arms 130 at a plurality of locations. The marker heads 140 may extend sufficiently away from the marker arms 130 to allow the marker heads 140 to contact the underlying surface (e.g. soil) when the marker arms 130 are in a second position 801 (FIG. 8). The marker heads 140 can be coupled to the marker arms 130 at a distance that corresponds to the desired row width. By coupling the marker heads 140 to the marker arms at the correct corresponding location, when the arm is in the second position 801, the marker head 140 may create an indentation in the underlying surface (e.g. soil) that can be a guide for subsequent rows to ensure even distribution of seed.

A marker arm 130 can also be maintained in the first position 131 by a locking mechanism 135. The locking mechanism 135 can be removably coupled to a boss 137 located on the marker arm 130. The boss 137 can be a cylindrical extrusion coupled to the marker arm 130. The boss 137 can extend sufficiently away from the marker arm 130 to allow the locking mechanism 135 to encompass the boss 137. When the locking mechanism 135 encompasses the boss 137, the marker arm 130 can be maintained in the first position 131.

As shown in FIG. 1, the locking mechanism 135 can be coupled to a pull string 136. When tension is applied to the pull string 136, the locking mechanism 135 can release the boss 137 and allow the marker arm 130 to pivot to the second position 801. The pull string 136 can run from the locking mechanism 135 through a guide ring 139. The pull string 136 can then either be tied to a trip lever 141 or run to the guiding vehicle. If sufficient tension is applied to the pull string 136 and the planter assembly 100 is in the engaged position as shown in FIG. 1, the locking mechanism 135 disengages and releases the marker arm 130 to the second position 801. One of ordinary skill in the art can appreciate the many ways which the marker arm 130 could be released, such as electrical or pneumatic switches, and thus should not take the mechanical locking mechanism 135 as a limited method of controlling the marker arm 130.

A marker arm 130 may be located on each frame member 120 and have a specific pull string 136 coupled thereto. The user may select which marker arm 130 to disengage by applying tension to the corresponding pull string 136. In one embodiment, either or both marker arms 130 can be released by applying tension to the corresponding pull string 136.

Also shown in FIG. 1, the frame member 120 can have a disc opener 108 and a drag chain 112 coupled thereto. The disc opener 108 can include a pair of plates for forming a furrow when engaging the underlying surface. The drag chain 112 can at least partially cover the furrow when the planter is being pulled by a guiding vehicle. In this manner, as the planter assembly 100 moves in a forward direction, the disc opener 108 engages the underlying surface first to create the furrow, and then after seed is deposited into the furrow, the drag chain 112 follows the disc opener 108 and covers the seed with soil. While this embodiment utilizes a disc opener 108 and drag chain 112, one skilled in the art could understand how similar methods such as opposed discs or scrapers could be used for the planting process.

Further, the planter assembly 100 can have a seed disc hopper 110 removably coupled to the frame member 120. The seed disc hopper 110 can be mechanically coupled to a drive wheel 104 partially through a seed disc sprocket 126, a final drive chain 128, and a secondary final drive sprocket 124. As the drive wheel 104 rotates, the axle 106 rotates a series of sprockets and drive chains to mechanically translate the rotation of the drive wheel 104 to the seed disc sprocket 126.

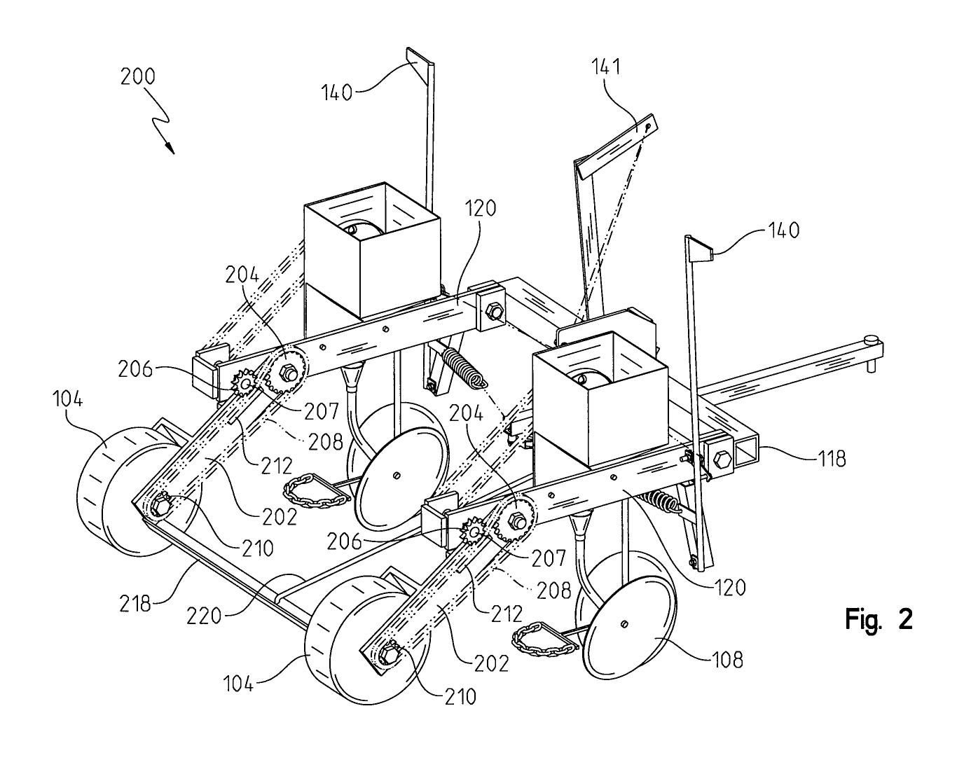

Referring to FIG. 2, the drive wheel 104 may be connected to the planter frame member 120 through a swing arm 202. The swing arm 202 may mount to the planter frame member 120 at an idler sprocket 204 axis of rotation. Further, a swing arm cross-member 218 can couple multiple swing arms 202 to one another. The swing arm system of this embodiment is not meant to limit the method used to engage the drive system 200 and disc opener 108. In other embodiments, hydraulics, winches, clutches, or the like could be used to engage/disengage these systems.

Further, the angular orientation of the swing arms 202 can be altered by a connecting rod 220 that runs from the swing arm cross-member 218 to the trip lever 141. The trip lever 141 may pivot between an engaged and a disengaged position. When the trip lever 141 is pivoted to the engaged position, the connecting rod 220 allows the planter assembly to assume the engaged position where the swing arms 202 have pivoted away from the frame members 120, the disc opener 108 contacts the underlying surface, and the rotational motion of the drive wheel 104 is translated to the seed disc sprocket 126. When the trip lever 141 is pivoted to the disengaged position, the connecting rod 220 pulls the swing arms 202 towards the tool bar 118, which raises the disc opener 108 at least partially above the surrounding surface and disengages the seed disc sprocket 126 from the drive wheel 104.

A primary drive sprocket 210 may be coupled to the drive wheel axle 106. The primary drive sprocket 210 can rotate as the drive wheel 104 rotates. The primary drive sprocket 210 can further be coupled to the idler sprocket 204 by a primary drive chain 208. The primary drive chain 208 may rotate a final drive sprocket 206 if the planter assembly 100 is in the engaged position. The final drive sprocket 206 may further be coupled to a final drive shaft 207 that translates the rotational motion of the final drive sprocket 206 to the secondary final drive sprocket 124 when the planter assembly 100 is in the engaged position. The final drive shaft 207 may be disposed within bearings (not shown) to allow the final drive shaft 207 to rotate freely about its axis. When the final drive sprocket 206 rotates with the primary drive chain 208, the secondary final drive sprocket 124 and the final drive chain 128 rotate the seed disc sprocket 126. Further, when the planter assembly 100 is in the disengaged position, the final drive sprocket 206 does not contact the primary drive chain 208 and the rotational motion of the drive wheel 104 is not translated to the seed disc sprocket 126. While this embodiment utilizes sprockets and chains, one skilled in the art could understand how belts and pulleys, hydraulics, gearing, or the like could be similarly used to achieve substantially similar results.

A backup block 212 may be located on the swing arm 202. The backup block 212 may be located on the opposite side of the primary drive chain 208 than the final drive sprocket 206. This location can allow the backup block 212 to provide a structural reinforcement to allow proper engagement between the final drive sprocket 206 and the primary drive chain 208 when engaged to one another. When the planter assembly 100 is in the engaged position, the final drive sprocket 206 presses the primary drive chain 208 against the backup block 212 and the final drive sprocket 206 rotates as the primary drive chain 208 rotates. The backup block 212 can be strong enough to allow the final drive sprocket 206 to be pressed against the primary drive chain 208 with sufficient force to restrict the final drive sprocket 206 from skipping links of the primary drive chain 208 as it rotates. Further, the backup block 212 can have sufficient frictional properties to allow the primary drive chain 208 to slide along the surface of the backup block 212 while being pressed into the backup block 212 by the final drive sprocket 206. The backup block 212 may be made of DuPont™ Teflon®, PVC, or any other material that has similar structural integrity and frictional properties.

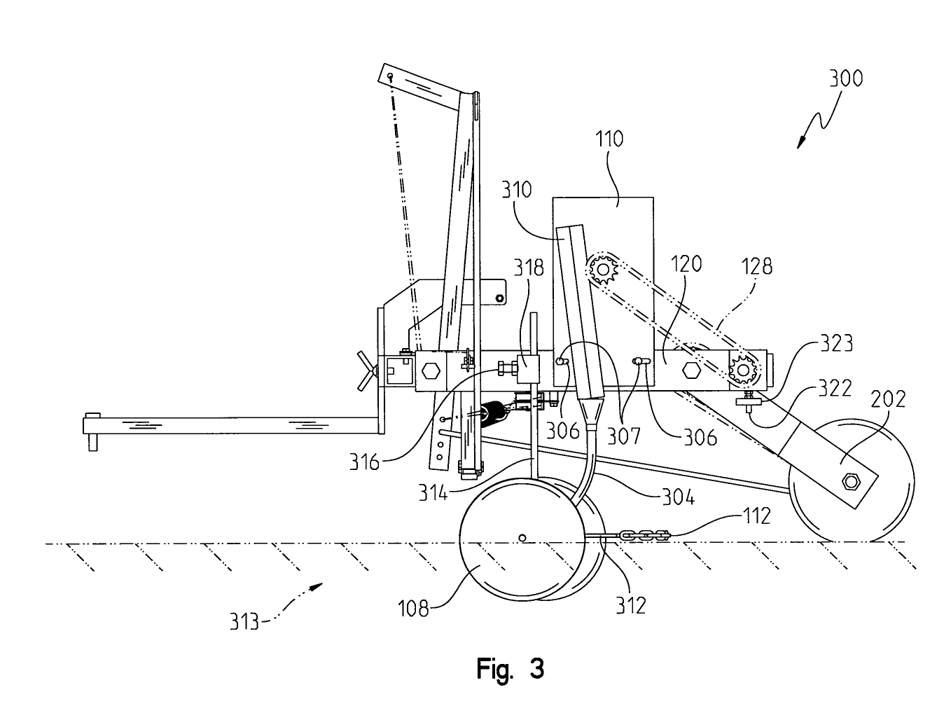

The planter assembly 300 shown in FIG. 3 is in the engaged position with the disc opener 108 contacting a ground surface 313. In this particular embodiment, the disc opener 108 can be adjustable to a plurality of depths. The disc opener 108 can be coupled to a disc opener shaft 314 that runs through a shaft sleeve 318. Further, the disc opener shaft 314 can be held in position by a disc opener shaft clamp 316. The disc opener shaft clamp 316 can be manipulated to release the disc opener shaft 314. Once the disc opener shaft 314 is released, it can slide about the shaft sleeve 318 to adjust the depth of the disc opener 108. When a desired depth is determined, the disc opener shaft clamp 316 can engage the disc opener shaft 314 and maintain the disc opener shaft 314 position. This particular embodiment is not meant to be exhaustive, one skilled in the art could understand how hydraulics, telescoping arms, or the like could replace the shaft and clamp design and the adjustability of the disc openers should not be limited to the shaft and clamp configuration.

Further illustrated in FIG. 3, a seed guide 310 is shown that can direct seed into a furrow created by the disc opener 108. The seed guide 310 can direct seed from the seed disc hopper 110 to a seed distribution tube 304. The seed distribution tube 304 can further be coupled to a drag chain mounting bracket 312 and direct the seed to a location between the disc openers 108 and the drag chain 112. The drag chain mounting bracket 312 can couple the drag chain 112 to the disc opener shaft 314 and allow the drag chain 112 to drag along the ground when the planter assembly 100 is in the engaged position and being pulled by a guiding vehicle.

In FIG. 3, a height stop adjustment 322 is shown. The height stop adjustment 322 can be located on the swing arm 202 at a location that allows the height stop adjustment 322 to contact the frame member 120. When the planter assembly 100 is in the engaged position, the frame member 120 can partially rest on the height stop adjustment 322. The height stop adjustment 322 can be coupled to the swing arm 202 through a support plate 323. The support plate 323 can be a base for the height stop adjustment 322 that allows the height stop adjustment 322 to protrude through the support plate 323 and to contact the frame member at plurality of heights. One example of the height stop adjustment 322 could be a threaded hole with a screw protruding through the support plate 323 and contacting the frame member 120. However, this embodiment should not be limited to such an application, one skilled in the art could realize the many ways the swing arm 202 could be adjusted such as hydraulics, a pin and hole combination, or the like.

The adjustability of the height stop adjustment 322 can allow the swing arm 202 to be positioned at a plurality of angles in comparison to the frame member 120. The particular angular orientation of the swing arm 202 can affect the engagement between the final drive sprocket 206 and the primary drive chain 208. When in the engaged position, the frame member 120 can rest partially on the height stop adjustment 322 while simultaneously providing sufficient engagement between the final drive sprocket 206 and the primary drive chain 208. As the angular orientation of the swing arm 202 is adjusted by the height stop adjustment 322, the amount of pressure applied to the primary drive chain 208 by the final drive sprocket 206 varies. For example, if the height stop adjustment 322 protrudes to far through the support plate 323, the final drive sprocket 206 may not sufficiently contact the primary drive chain 208 and the rotation of the drive wheel 104 will not be translated to the seed disc sprocket 126. Further, if the height stop adjustment 322 does not protrude far enough through the support plate 323, the final drive sprocket 206 may be pressed into the primary drive chain 208 with sufficient pressure to pinch the drive chain 208 against the backup block 212 and prohibit the rotation of the primary drive chain 208.

The seed disc hopper 110 may be removably coupled to the frame member 120 by a plurality of coupling mechanisms 307 and slots 306. The slots 306, which are defined in the seed disc hopper 110, can allow the seed disc hopper 110 to be removably coupled to the frame member 120 in a plurality of locations. The coupling mechanisms 307, such as nuts and bolts, screws, or studs, can be coupled to the frame member 120 and protrude through the slots 306. The coupling mechanisms 307 can allow the seed disc hopper 110 to slide along the slots 306 relative to the coupling mechanisms 307 while in an uncompressed configuration. Further, when the coupling mechanisms 307 are in the compressed configuration, the coupling mechanisms can provide a sufficient compressive force to keep the seed disc hopper 110 from sliding along the slots 306. The slots 306 may substantially restrict the seed disc hopper 110 from changing in angular orientation compared to the frame member 120. As the seed disc hopper 110 is slid relative to the coupling mechanisms 307 along the frame member 120, the tension in the final drive chain 128 can be increased or decreased. When the proper tension in the final drive chain 128 is achieved, the coupling mechanisms 307 can maintain the compressed configuration and the position of the seed disc hopper 110 along the slots 306 will be preserved.

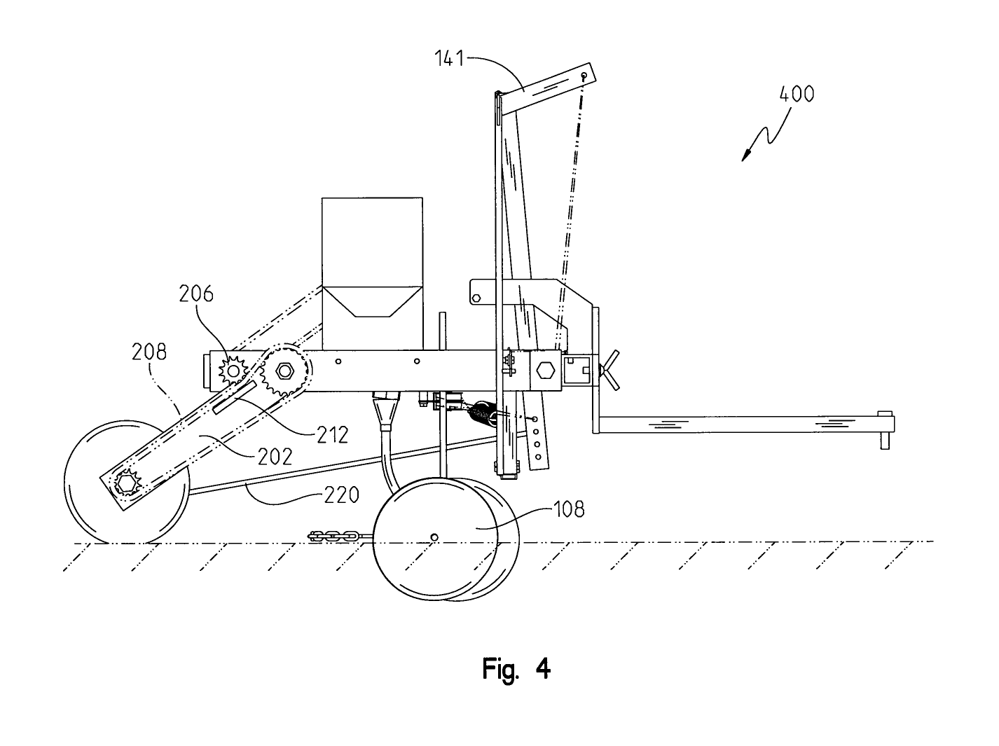

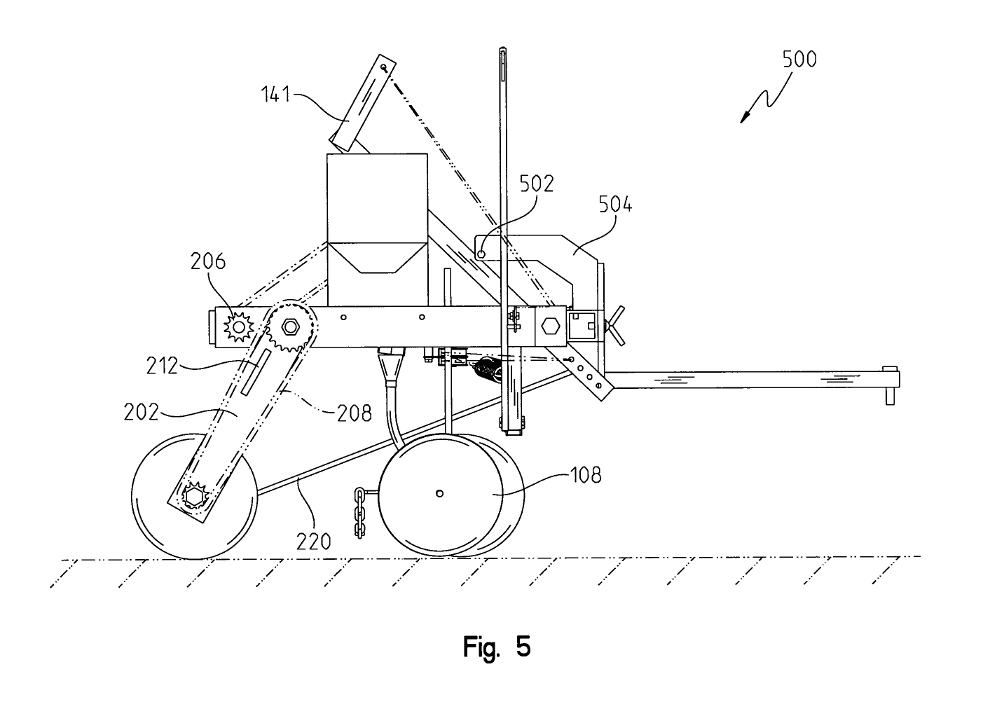

The planter assembly 100 is capable of being disposed in an engaged 400 position (FIG. 4) and a disengaged position 500 (FIG. 5). In the engaged position 400 shown in FIG. 4, the final drive sprocket 206 presses the primary drive chain 208 against the backup block 212 and allows the final drive sprocket 206 to rotate as the primary drive chain 208 rotates. Further, the relationship between the connecting rod 220 and the trip lever 141 is shown where the connecting rod 220 allows the swing arms 202 to rest at least partially on the height stop adjustment 322 in order to maintain the engaged position 400.

Further, in the disengaged position 500, a trip lever stop 502 may be located on a trip arm brace 504. The trip lever stop 502 may engage and retain the trip lever 141 in the disengaged position 500. When the swing arm 202 is rotated to the disengaged position 500 from the engaged position 400, as the trip lever 141 rotates about a pivot point, the connecting rod 220 pulls the swing arms 202 toward the tool bar 118 which raises the disc opener 108 above the ground and disengages the final drive sprocket 206 from the primary drive chain 208. Lastly, to move the trip lever 141 from the disengaged position 500 to the engaged position 400, the trip lever 141 can be deflected sufficiently away from the trip lever stop 502 to bypass the trip lever stop 502 and move to the engaged position 400.

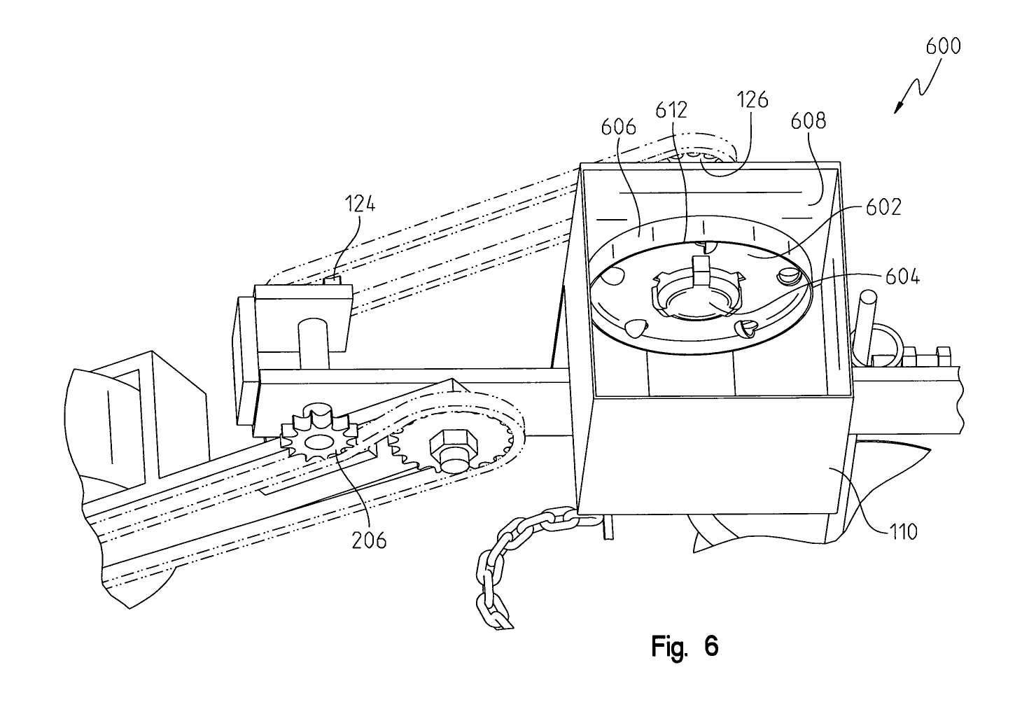

A seed disc hopper 110 is shown in FIG. 6 that has a seed disc 602 removably coupled to a seed disc hub 604. The seed disc hub 604 can be coupled to the seed disc sprocket 126. The seed disc hub 604 can rotate as the seed disc sprocket 126 rotates. The seed disc 602 may also have an inner opening with a diameter sufficient to allow the seed disc 602 to encompass, and be removably coupled to, the seed disc hub 604. In one embodiment 600, the seed disc hub 604 is configured to receive seed discs 602 of different types in order to accommodate a plurality of different seed types. The seed disc hub 604 may be compatible, for example, with seed discs 602 designed to distribute lettuce, corn, beans, or the like.

The seed disc 602 can also freely rotate while being circumferentially surrounded by a ring disc guard 606. The ring disc guard 606 can extend away from an interior hopper wall 608 and terminate at an outer lip or rim 612 that extends slightly past the exterior face of the seed disc 602. The ring disc guard 606 can prevent seed from getting lodged between the seed disc 602 and the seed disc hopper 110 when the seed disc 602 is rotating with the seed disc hub 604.

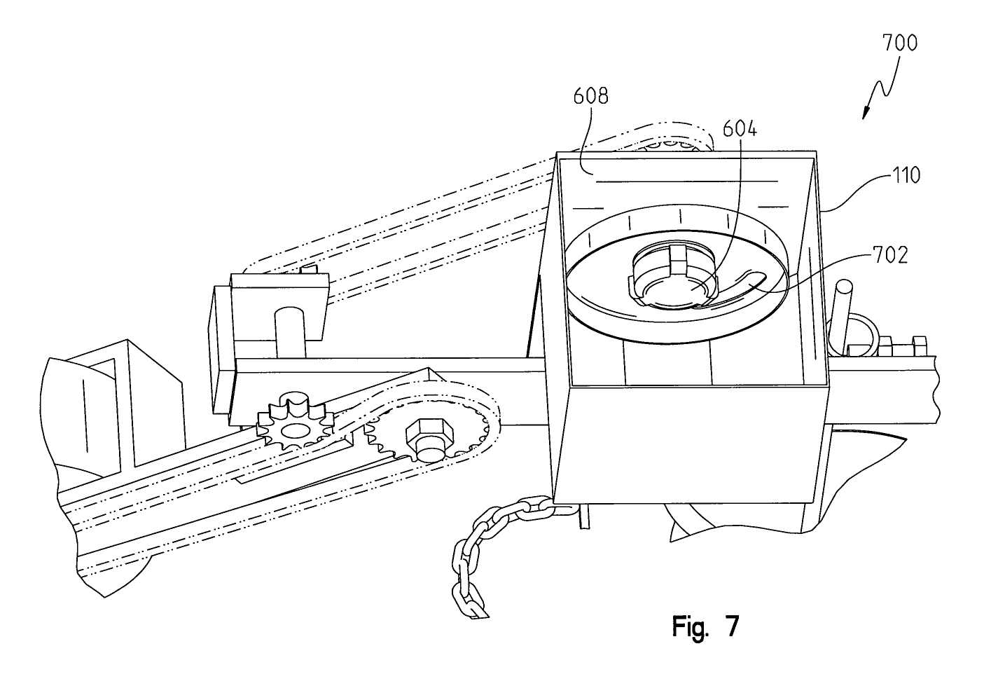

In FIG. 7, a seed disc hopper 110 is shown 700 without the seed disc 602 coupled to the seed disc hub 604. A dropout opening 702 is defined in the interior hopper wall 608 of the seed disc hopper 110. The dropout opening 702 provides a path for a seed to be transported from the seed disc hopper 110 and into the seed guide 310 (FIG. 3). When the seed disc 602 is coupled to the seed disc hub 604 and the seed disc hopper 110 is filled with seed, as the seed disc 602 rotates it distributes one or more seed through the dropout opening 702 and into the seed guide 310 to be directed by the seed distribution tube 304 to an open furrow created by the disc opener 108.

Finally, FIG. 8 shows a rear view of the planter assembly 100 in the engaged position 800. In this view, a trip lever pivot point 804 is shown. The trip lever pivot point 804 can be coupled to the tool bar 118. Further, the trip lever pivot point 804 can be pivotally coupled to the trip lever 141. The trip lever pivot point 804 can be the axis of rotation for the trip lever 141 to allow the trip lever 141 to be oriented in the engaged position 400 or the disengaged position 500.

The marker arms 130 are also shown in FIG. 8. The marker arms 130 can be coupled to a marker return arm 805. The marker return arm 805 can further be coupled to a spring 806 which is coupled to the marker return arm 805 on one end and to a cable 808 on the other. The cable 808 can extend from the spring 806, through a pulley 802, and be coupled to the trip lever 141 at a location under the trip lever pivot point 804. When the trip lever 141 is in the engaged position 400, the cable 808 and the spring 806 allow either of the marker arms 130 to pivot down to the second position 801 if the locking mechanism 135 is disengaged by the pull string 136.

Further, when the trip lever 141 is moved from the engaged position 400 to the disengaged position 500, the cable 808 is pulled by the base of the trip lever 141. As the trip lever 141 rotates about the trip lever pivot point 804, the tension in the cables 808 can provide sufficient tension to the spring 806 and the marker return arm 805 to pivot any marker arm 130 in the second position 801 back to a the first position 131. When returned to the first position 131, the locking mechanism 135 can maintain the marker arms 130 in the first position 131.

The planter assembly 100 shown in FIG. 8 can have a first frame member assembly 810 and a second frame member assembly 812. Each frame member assembly 810, 812 can be adjustable along the tool bar 118 to allow for a plurality of row widths to be planted. The swing arm cross-member 218 may accordingly be adjustable to fit a plurality of widths. As the frame members 810 and 812 can be adjusted on the tool bar 118 to accommodate a plurality of widths, the swing arm cross-member 218 may be adjustable to accommodate several row widths as well. Further, additional frame member assemblies could be added to the tool bar 118 to plant more than 2 rows at one time. The present disclosure should be understood to allow a plurality of row widths between the frame member assemblies and further accommodate a plurality of frame members on the tool bar.

While embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fail within the limits of the appended claims.

1. A planter assembly to be driven by a single-point hitch machine for planting seed, comprising:
a coupler having a first end and a second end, the first end configured to be coupled to the single point hitch of the machine;
a tool bar coupled to the second end of the coupler via a coupler plate, the coupler plate including a plurality of defined openings for adjustably coupling the tool bar to the coupler;
a frame coupled to the tool bar;
a swing arm pivotally coupled to the frame, the swing arm being pivotable between a first position and a second position;
a wheel for propelling the planter assembly, the wheel being coupled to the swing arm; and
a final drive sprocket coupled to the frame, the final drive sprocket being engaged with a drive chain when the swing arm is in the first position and disengaged from the drive chain when the swing arm is in the second position.

2. The planter assembly of claim 1, wherein the second end of the coupler is adjustably coupled to the tool bar via the plurality of openings defined in the coupler plate.

3. The planter assembly of claim 1, wherein the wheel is in contact with the underlying surface in both the first position and the second position.

4. The planter assembly of claim 1, further comprising:
a seed hopper including a plurality of sides that define an interior configured to hold seeds;
a seed hub disposed in the interior of the seed hopper, the seed hub rotatably driven by the wheel; and
a seed disc rotatably coupled to the seed hub;
wherein, rotation of the seed hub induces substantially concomitant rotation of the seed disc.

5. The planter assembly of claim 4, further comprising a seed disc sprocket rotatably coupled to the seed hub, wherein in the first position the wheel is rotatably coupled to the seed hub.

6. The planter assembly of claim 4, wherein when the swing arm is in the second position, the seed hub is decoupled from the wheel.

7. The planter assembly of claim 1, further comprising a reinforcement block disposed adjacent to the drive chain, wherein when the swing arm is in the first position the final drive sprocket contacts the drive chain and forces the drive chain against the reinforcement block.

8. The planter assembly of claim 1, further comprising a marker having a first end and a second end, the marker including a head removably coupled to the first end and being pivotally coupled to the frame at the second end.

9. The planter assembly of claim 8, wherein the marker is pivotable relative to the frame between an engaged position and a disengaged position;
further wherein, in the disengaged position the marker is disposed in an upright position, and in the engaged position the marker is pivotably disposed at a substantially perpendicular position relative to the upright position such that the head is disposed in contact with an underlying surface.

10. A planter machine for distributing multiple rows of seed, comprising:
a powered machine including a single point hitch;
a planter assembly comprising:
a frame;
a first wheel and a second wheel for propelling the machine along an underlying surface, the first wheel and the second wheel coupled to the frame;
a coupling mechanism having a first end and a second end, the first end being coupled to the single point hitch and the second end being coupled to the frame;
a first swing arm coupled to a first side of the frame and a second swing arm coupled to a second side of the frame, the first side being opposite the second side;
a swing arm cross member coupled between the first swing arm and the second swing arm; and
a trip lever coupled to the swing arm cross member, the trip lever being pivotable between a first position and a second position;
wherein, as the trip lever is pivoted from the first position to the second position, the first swing arm and the second swing arm move the frame relative to the underlying surface.

11. The planter machine of claim 10, further comprising:
a first seed hopper adjustably coupled to the first side of the frame, the first seed hopper including a first seed disc hub rotatably coupled to the first seed hopper;
a second seed hopper adjustably coupled to the second side of the frame, the second seed hopper including a second seed disc hub rotatably coupled to the second seed hopper;
a first seed disc rotatably coupled to the first seed disc hub;
a second seed disc rotatably coupled to the second seed disc hub;
wherein, when the trip lever is in the first position, the first seed disc hub is rotatably coupled to the first wheel and the second seed disc hub is rotatably coupled to the second wheel.

12. The planter machine of claim 11, further comprising:
a first seed distribution assembly coupled to the first seed hopper, the first seed distribution assembly including a first guide and a first distribution tube, where the first guide is coupled to the first seed hopper and is configured to receive a seed from the first seed disc and guide the received seed to the first distribution tube;
a second seed distribution assembly coupled to the second seed hopper, the second seed distribution assembly including a second guide and a second distribution tube, where the second guide is coupled to the second seed hopper and is configured to receive a seed from the second seed disc and guide the received seed to the second distribution tube;
a first disc opener coupled to the first side of the frame, the first disc opener being movable between a raised position and a lowered position, where in the lowered position the first disc opener is configured to engage the underlying surface and form a first furrow; and
a second disc opener coupled to the second side of the frame, the second disc opener being movable between a raised position and a lowered position, where in the lowered position the second disc opener is configured to engage the underlying surface and form a second furrow;
wherein, the first distribution assembly is adapted to transfer a seed from the first seed hopper and release it into the first furrow, and the second distribution assembly is adapted to transfer a seed from the second seed hopper and release it into the second furrow.

13. The planter machine of claim 12, further comprising:
a first drag chain coupled to the first disc opener; and
a second drag chain coupled to the second disc opener;
wherein, the first drag chain is configured to cover the seed released in the first furrow with a portion of the underlying surface, and the second drag chain is configured to cover the seed released in the second furrow with a portion of the underlying surface.

14. The planter machine of claim 11, wherein:
the first seed disc and the second seed disc each comprise a substantially disc-shaped body, the disc-shaped body including a substantially centrally-defined bore for coupling to the first or second seed disc hub, an outer disc guard that forms an outer lip, and a plurality of defined openings radially offset from one another; and
the first seed hopper and the second seed hopper each include a plurality of sides, where at least one of the plurality of sides defines an opening;
further wherein, during rotation of the first or second seed disc hub, at least one of the plurality of defined openings in the disc-shaped body of the corresponding seed disc is substantially aligned with the opening defined in the corresponding seed hopper to release a seed from the corresponding seed hopper through the aligned openings.

15. The planter machine of claim 11, further comprising:
a drive sprocket rotatably coupled to one end of the first or second swing arm, the drive sprocket being rotatably driven by the first or second wheel;
a driven sprocket coupled to an opposite end of the first or second swing arm and fixedly coupled to the frame;
a drive chain coupled between the drive sprocket and the driven sprocket;
an idler sprocket coupled to the frame, the idler sprocket positioned adjacent to the driven sprocket;
a seed disc sprocket coupled to the first or second seed hopper, the seed disc sprocket rotatably coupled to the first or second seed disc such that rotation of the seed disc sprocket induces substantially concomitant rotation of the first or second seed disc;
a seed disc chain coupled between the seed disc sprocket and the idler sprocket;
wherein, rotation of the first or second wheel induces rotation of the first or second seed disc hub via the drive chain and the seed disc chain.

16. A two-row planting assembly for being driven by a machine having a single-point hitch, comprising:
a frame;
a coupling mechanism having a first end and a second end, the first end being coupled to the frame and the second end configured to be coupled to the single-point hitch;
a wheel coupled to the frame and configured to propel the two-row planting assembly along an underlying surface;
a disc opener adjustably coupled to the frame, the disc opener configured to form a furrow in the underlying surface;
a drag chain adjustably coupled to the frame, the drag chain configured to be dragged behind the disc opener and cover up the furrow with a portion of the underlying surface;
a seed hopper coupled to the frame, the seed hopper including a plurality of sidewalls that define an interior for holding seed;
a seed hub rotatably coupled to one of the plurality of sidewalls;
a seed disc including a defined bore and a plurality of openings radially spaced from the defined bore and each other, the seed disc being rotatably coupled to the seed hub;
a swing arm pivotally coupled to the frame, the swing arm configured to have a first position and a second position;
a plurality of sprockets coupled to the wheel, swing arm, frame, and disc hub;
a trip lever pivotally coupled to the frame, the trip lever being movable between an engaged position and a disengaged position;
wherein, in the first position the disc opener is adapted to engage the underlying surface and a rotation of the wheel induces substantially concomitant rotation of the seed disc, and in the second position the disc opener is disposed in a position in which the disc opener is not configured to engage the underlying surface.

17. The two-row planting assembly of claim 16, wherein:
when the trip lever is in the engaged position, the swing arm is in the first position; and
when the trip lever is in the disengaged position, the swing arm is in the second position.

18. The two-row planting assembly of claim 16, further comprising:
a marker pivotally coupled to the frame, the marker being disposable between a lowered position and a raised position;
a marker head coupled to the marker, wherein in the lowered position the marker head is configured to contact the underlying surface; and
a marker lock coupled to the frame, the marker lock removably coupling the marker to the frame in the raised position.

19. The two-row planting assembly of claim 18, further comprising:
a connecting line coupled to the trip lever and the marker;
a pulley coupled to the frame, the pulley configured to partially guide the connecting line from the trip lever to the marker; and
a pull string coupled to the marker lock;
wherein, in the raised position a movement of the pull string releases the marker from the frame and induces the marker to move from the raised position to the lowered position.

20. The two-row planting assembly of claim 19, wherein:
the marker is disposed in the first position when the trip lever is disposed in the disengaged position; and
the marker is disposed in the second position when the trip lever is disposed in the engaged position.
